(19) United States
(12) Patent Application Publication
(10) Pub. No.: US 2026/0251048 A1
(43) Pub. Date: Aug. 27, 2026

(54) DRILLING RIG POWER MANAGEMENT BASED ON DRILL PLANS

(71) Applicant: Schlumberger Technology Corporation, Sugar Land, TX (US)

(72) Inventors: Nick Paul Krippner, Katy, TX (US); Paul Wyman, Katy, TX (US); Mateo Garcia, Katy, TX (US); Alyssa Brown, Katy, TX (US)

(21) Appl. No.: 19/208,213

(22) Filed: May 14, 2025

Related U.S. Application Data
(60) Provisional application No. 63/761,314, filed on Feb. 21, 2025.

(51) Int. Cl. E21B 44/00; H02J 3/32; H02J 3/38

(52) U.S. Cl. CPC E21B 44/00; H02J 3/32; H02J 3/38; H02J 2103/30

(57) ABSTRACT

A rig power management system may identify a power demand for drilling equipment of a drilling rig performing an operation at a wellbore. A rig power management system may provide the power demand to the drilling rig with an operating profile. The operating profile includes a combination of at least one generator of a plurality of generators and stored energy capacity of an energy storage system. A rig power management system may generate a predicted operating profile different from the operating profile using a drill plan for a wellbore. The drill plan includes a planned operation, the planned operation including operating parameters for the drilling equipment to perform the planned operation. A rig power management system may implement the predicted operating profile before starting the planned operation or at a start of the planned operation.

This Application claims priority to and the benefit of U.S. Provisional Patent Application No. 63/761,314 filed on Feb. 21, 2025, which is hereby incorporated by reference in its entirety.

### BACKGROUND OF THE DISCLOSURE

Downhole drilling systems include multiple pieces of equipment. The equipment performs drilling activities, advancing a wellbore, reaming a wellbore, installing drill pipe, removing drill pipe, installing casing, grouting, pumping drilling fluid, performing administrative tasks, any other drilling activity, and combinations thereof. Electrical power may be supplied to the equipment in any manner. For example, a rig power supply system may include generators, grid power, battery power, and so forth. Electrical power may be a large expense and source of carbon emissions for a drilling system.

### SUMMARY

In some aspects, the techniques described herein relate to a method for rig power management. A rig power management system identifies a power demand for drilling equipment of a drilling rig performing an operation at a wellbore. The rig power management system provides the power demand to the drilling rig with an operating profile. The operating profile includes a combination of at least one generator of a plurality of generators and stored energy capacity of an energy storage system. The rig power management system generates a predicted operating profile different from the operating profile using a drill plan for a wellbore. The drill plan includes a planned operation including operating parameters for the drilling equipment to perform the planned operation. The rig power management system implements the predicted operating profile before starting the planned operation or at a start of the planned operation.

In some aspects, the techniques described herein relate to a method for rig power management. A rig power management system provides power, with an operating profile, to satisfy a power demand for drilling equipment of a drilling rig performing an operation at a wellbore. The operating profile includes a combination of generator power supplied by a set of generators and stored energy capacity of an energy storage system. The rig power management system changes the operating profile based on a planned operation including operating parameters for the drilling equipment to perform the planned operation.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1 is a representation of a drilling system for drilling an earth formation, according to at least one embodiment of the present disclosure.

FIG. 2 is a schematic representation of a rig power management system, according to at least one embodiment of the present disclosure.

FIG. 3 is a representation of a rig power management system, according to at least one embodiment of the present disclosure.

FIG. 4 is an example power generation plot illustrating power generation over time, according to at least one embodiment of the present disclosure.

FIG. 5 is a flowchart of a method for rig power management, according to at least one embodiment of the present disclosure.

FIG. 6 is a flowchart of a method for rig power management, according to at least one embodiment of the present disclosure.

FIG. 7 is a representation of a computing system, according to at least one embodiment of the present disclosure.

### DETAILED DESCRIPTION

This disclosure generally relates to a power management system for providing electrical power to a drilling system, including a drill rig, and other devices which operate based on electrical power. In many cases, the power demand, load, or power draw of a drilling system may change over time, such as transient changes (e.g., spikes, dips) or more gradual, steady-state changes. For example, during drilling operations, changes in drilling conditions, transitioning between different drilling operations, and other changes of the drilling rig may cause the power demand to vary. Accordingly, the power management system may adapt to the changing power needs of a drilling system in order to meet this variable power demand.

A drilling rig may receive power from a rig generator set (genset). While in some cases, gensets may be equipped to provide variable amounts of power to meet transient and/or gradual changes to the power demand, in some cases, generators may operate inefficiently and/or may experience damage or wear by varying or changing the amount of power they generate. In some cases, generators may even be incapable of adapting (e.g., quickly enough) to some variations in power demand, such as extreme transient changes in magnitude or duration. The power management system may include a battery energy storage system (BESS) to accompany the genset and to provide supplemental power to meet changing power demands. For instance, the BESS may be a battery storage system, which may store a finite capacity of electrical energy, and which may discharge that energy in order to supplement the power provided by the genset. Accordingly, the power management system may be a hybrid system, and may advantageously charge and discharge the BESS, in addition to power generation with the genset, in order to meet the power demand of the drilling system.

In some cases, the generators of the genset may be characterized by an efficiency threshold at which the generators may operate most efficiently. For example, the efficiency threshold may be a threshold value or range of power output at which the generators can maximize the amount of electrical energy generated per unit of fuel. For instance, in some cases, the generators operate most efficiently at 75% (or other threshold) of a maximum power capacity of the generators.

In some embodiments, the power management system may facilitate operating the generators at the efficiency threshold, to the extent possible, in order to maximize the fuel efficiency of the power generated by the genset. To achieve this, the power management system may operate the genset at the efficiency threshold to meet the power demand of the drilling system, and changes to the power demand may be accommodated by the BESS. For instance, should the power demand increase above the genset efficiency threshold (e.g., for a transient period or a steady-state change) the BESS may discharge some or all of its power capacity to meet the increased load, thus maintaining the genset at the efficiency threshold. In another example, should the power demand decrease below the genset efficiency threshold, the genset may continue operating at the efficiency threshold, and the BESS may charge from the excess power.

In this way, the power management system may leverage the BESS in order to maximize the power generated by the genset per unit of fuel consumed by charging and discharging the BESS at opportune times. In some cases, the power management system may control a rate at which the BESS charges and discharges in order to prevent wear and/or damage to the BESS. For example, the power management system may monitor an average power transfer rate to and from the BESS over a monitoring period, and may limit or control the average rate at which the BESS charges and discharges in order to maintain the average power transfer rate within a threshold. For instance, the threshold for the average power transfer rate may be based on a C-rate for the energy cells of the BESS. Accordingly, the power management system may utilize the BESS as a supplement to the genset, and may do so within the limits of the average power transfer rate.

In some situations, during operation, a change in steady-state drilling conditions may occur based on a change in the operation of the drilling system. For example, a change in drilling operation, geological conditions, equipment activated, or other change in conditions, may result in a different power demand. This may cause a change in the utilization of the generators and/or a change in the portion of the power demand absorbed by or powered by the energy storage system. During the transition, the generators may operate at less than the peak utilization efficiency, thereby reducing the fuel efficiency of the drilling system.

In accordance with at least one embodiment of the present disclosure, a rig power management system may incorporate planned operations to determine the operating profile of the power generation system. The operating profile may be the combination of generator power and stored energy capacity of an energy storage system. For example, the operating profile may include the portion of the power demand provided by the energy storage system. For example, the rig power management system may identify a planned power demand for the planned operation. If the planned power demand is different than the current power demand, the rig power management system may generate a new operating profile of the power generation system. The rig power management system may implement the new operating profile to reduce the impact of the change in the power demand. For example, the rig power management system may, prior to the start of the planned operation, change or begin the change to the new operating profile. In some examples, the rig power management system may change or begin the change to the new operating profile when the new operation begins, which may be prior to the change implemented by analyzing the power demand and associated power profile. In this manner, the rig power management system may proactively change the operating profile, thereby reducing the amount of time that the power generation system operates outside of the efficiency utilization and increasing overall fuel economy.

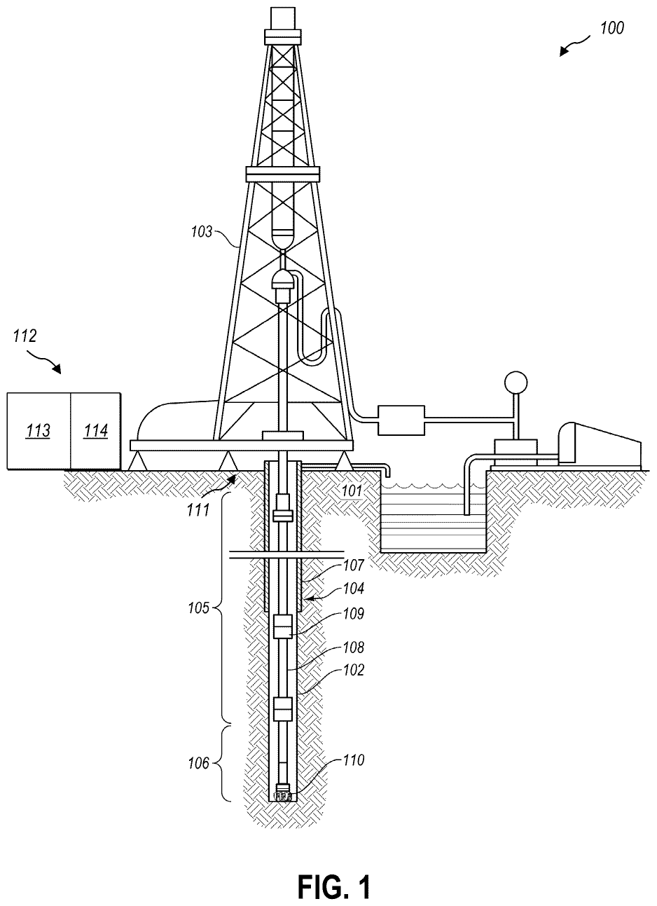

FIG. 1 shows one example of a drilling system 100 for drilling an earth formation 101 to form a wellbore 102. The drilling system 100 includes a drill rig 103 used to turn a drilling tool assembly 104 which extends downward into the wellbore 102. The drilling tool assembly 104 may include a drill string 105, a bottomhole assembly (“BHA”) 106, and a bit 110, attached to the downhole end of drill string 105.

The drill string 105 may include several joints of drill pipe 108 connected end-to-end through tool joints 109. The drill string 105 transmits drilling fluid through a central bore and transmits rotational power from the drill rig 103 to the BHA 106. In some embodiments, the drill string 105 may further include additional components such as subs, pup joints, etc. The drill pipe 108 provides a hydraulic passage through which drilling fluid is pumped from the surface 111. The drilling fluid discharges through selected-size nozzles, jets, or other orifices in the bit 110 for the purposes of cooling the bit 110 and cutting structures thereon, and for lifting cuttings out of the wellbore 102 as it is being drilled.

As mentioned, the drilling system 100 includes a BHA 106. The BHA 106 may include the bit 110 or other components. An example BHA 106 may include additional or other components (e.g., coupled between to the drill string 105 and the bit 110). Examples of additional BHA components include drill collars, stabilizers, measurement-while-drilling (“MWD”) tools, logging-while-drilling (“LWD”) tools, downhole motors, underreamers, section mills, hydraulic disconnects, jars, vibration or dampening tools, other components, or combinations of the foregoing. The BHA 106 may further include a rotary steerable system (RSS). The RSS may include directional drilling tools that change a direction of the bit 110, and thereby the trajectory of the wellbore. At least a portion of the RSS may maintain a geostationary position relative to an absolute reference frame, such as gravity, magnetic north, and/or true north. Using measurements obtained with the geostationary position, the RSS may locate the bit 110, change the course of the bit 110, and direct the directional drilling tools on a projected trajectory.

In general, the drilling system 100 may include other drilling components and accessories, such as special valves (e.g., kelly cocks, blowout preventers, and safety valves). Additional components included in the drilling system 100 may be considered a part of the drilling tool assembly 104, the drill string 105, or a part of the BHA 106 depending on their locations in the drilling system 100.

The bit 110 in the BHA 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, or combinations thereof. For instance, the bit 110 may be used with a whipstock to mill into casing 107 lining the wellbore 102. The bit 110 may also be a junk mill used to mill away tools, plugs, cement, other materials within the wellbore 102, or combinations thereof. Swarf or other cuttings formed by use of a mill may be lifted to surface, or may be allowed to fall downhole.

The elements of the drilling system 100 may be powered by a rig power supply system 112. The rig power supply system 112 may include a rig generator set (genset) 113 and a BESS 114. In some embodiments, one or more elements of the rig power supply system 112 are located on-site. For example, the rig power supply system 112 may be built and maintained at a location proximate to the drilling system 100, including on land owned or leased by the owner of the drilling system 100, within sight of the drilling system 100, or within an on-site distance of the drilling system 100. The on-site distance may be any distance, including 5 m, 10 m, 25 m, 50 m, 100 m, 250 m, 500 m, 1,000 m, 1,500 m, any other distance, and combinations thereof. In some embodiments, on-site power is power that is generated exclusively for the drilling system 100. In some embodiments, on-site power is power that is generated for the drilling system 100 and other drilling and/or hydrocarbon-processing systems located near the drilling system 100.

The genset 113 may include one or more generators. For example, the generators may be combustion engines powered by a combustion fuel such as diesel, gasoline, natural gas (or other gas such as propane), any other hydrocarbon, hydrogen, any other combustion fuel, and combinations thereof.

The BESS 114 may be an energy storage comprising one (and often many) battery-energy cells. For example, the BESS 114 may include a plurality of energy cells which may be configured in an architecture including one or more modules of multiple energy cells, and one or more racks of multiple modules. In some cases, the battery energy cells may be representative of a smallest individual energy storage unit or component of the BESS. In some embodiments the battery cells are lithium-ion battery cells, but may also include any other type of battery storage type and/or chemical makeup. The BESS 114 may be rechargeable and may store energy for use by the drilling system 100. For example, energy may be added to the battery cells of the BESS 114 and stored as chemical and/or potential energy. The BESS 114 may discharge the potential energy to convert it to electricity.

As discussed herein, during operation of the drilling system 100, the powered elements of the drilling system 100 may draw power from the rig power supply system 112 with a power demand, load, or power draw. The power demand may be the total amount of power drawn from the rig power supply system 112 by all of the electronic components of the drilling system 100. In some cases, the power demand fluctuates or varies. For example, changes in the operating status of the various components of the drilling system 100 may increase or decrease their respective power draw. As a particular example, changes in a formation that a drill string is interacting with, transitions between different operations of the drilling system 100, pauses or halts of a drilling operation, or other causes may result in the power draw changing. The changes may be transient such as large peaks or dips, or may be more gradual changes to the steady-state operation of the power demand.

In some embodiments, the rig power supply system 112 is configured to provide a variable power to the drilling system 100 to meet the variable demand. For example, the genset 113 may be operated to provide a baseline and/or steady state power, and any changes to this baseline (e.g., above or below the baseline) may be provided by the BESS 114. To elaborate, the genset 113 may have an efficiency threshold, which may be a power draw, load, or output of the generators that corresponds with a maximum efficiency of the generators. For example, the efficiency threshold may be an operating state of the generators which achieves a greatest fuel efficiency, or converts or produces the most amount of electrical power per unit of fuel. In some cases, the efficiency threshold may be between 70% and 80% of a maximum power capacity of the generators, such as 75% of the power capacity. For example, each generator of the genset 113 may have a power capacity of between 750 kW and 1250 kW, such as about 1000 kW. In some cases, the efficiency threshold may be a power output of 750 kW for each generator of the genset 113.

Operating one or more generators of the genset over the efficiency threshold may result in diminished returns, or may not net a proportional amount of power generated per additional unit of fuel consumed. The operating efficiency of the genset 113 may be a predetermined threshold, such as a threshold defined through a specification of the generators, through empirical observation, etc. In some embodiments, each generator of the genset 113 may have the same efficiency threshold, or one or more generators may have a different efficiency threshold. Similarly, operating below the efficiency threshold may also result in a reduced fuel efficiency. Accordingly, it may be advantageous to operate the genset to provide the power demand at the efficiency threshold, to the extent possible, for an extended period of time, or even indefinitely. In this way, operating the genset 113 at the efficiency threshold may decrease an operating cost of the drilling system 100, such as improving fuel consumption, carbon emission, operational expenditure, tool life, or other beneficial outcomes of the drilling system 100.

In some cases, the BESS 114 may be operated to provide supplemental or auxiliary power in addition to that of the genset 113 to provide power to the drilling system 100. For example, the BESS 114 may be advantageously utilized to maintain the genset 113 operating at the efficiency threshold, while accommodating for changes in the power demand (e.g., power demands greater or less than the efficiency threshold) with the BESS 114. As an illustrative example, in some cases, the power demand may increase over that which the genset 113 can provide at the efficiency threshold, and the BESS 114 may be utilized to discharge additional or supplemental energy to meet the power demand. To elaborate, in some cases the power demand may be between about 750 kW and 1250 kW, and the power demand may experience one or more increases and/or decreases. For example, a steady state of the power demand may increase (e.g., gradually and/or steadily) within the 750 kW-1250 kW range, or transient changes to the power demand may spike as high as 1.5 MW. Rather than ramp up power generation of the genset 113 (e.g., including bringing additional generators online) to meet this increased demand which in some cases can cause wear, damage, or inefficiencies of the genset 113, the genset 113 may be maintained at the efficiency threshold and the BESS 114 may be discharged to provide the additional power. In another example, the power demand may decrease below that which the genset 113 can provide at the efficiency threshold (e.g., such as transient drops as low as 0 W), and the genset 113 may be maintained at the efficiency threshold with the additional energy being input to the BESS 114 to charge the BESS 114.

The BESS 114 has an energy storage capacity, or an amount of electrical energy which can be stored by the battery cells of the BESS. For example, the energy storage capacity may be the capacity of energy storage in ampere-hours (Ah), Watt-hour (Wh), kilowatt-hours (kWh), Megawatt-hours (MWh), Gigawatt-hours (GWh), and so forth. In some cases, the energy storage capacity of the BESS is between 200 and 500 kWh, such as about 350 kWh. The BESS 114 may have a state of charge (SOC), which may be a representation of the amount of available and/or accessible energy in the BESS 114. In some embodiments, the SOC is a percentage of the total energy storage capacity of the BESS 114.

In accordance with at least one embodiment of the present disclosure, a rig power management system may receive a drill plan for one or more operations to be performed by the drilling system 100. The drill plan may include operations performed to drill the wellbore 102, install casing, ream the wellbore, install a lateral, perform a survey with one or more downhole tools, trip drilling equipment into the wellbore 102, trip drilling out of the wellbore 102, drill through different formations, and so forth. Each operation may have different operating parameters, such as WOB, rotational rate, drilling fluid flow rate, and so forth. This may result in different power profiles, resulting in a different operating profile for the rig power supply system 112.

Conventionally, changing between operating profiles is reactionary. During operation, the rig power management system may monitor the power demand from the drilling equipment as the demand changes. Put another way, the rig power management system may monitor the changes to the power demand as the drilling equipment changes operating parameters. This may result in the genset 113 operating inefficiently until the rig power management system changes the operating profile.

In many situations, changes in the operating parameters of the drilling system 100 may be known in advance. For example, the drilling system 100 may include a drill plan to plan the operations used to drill the wellbore 102 and install the associated structures. The drill plan may include multiple discrete operations, and each of the operations may include estimated operating parameters. For example, advancing the depth of the wellbore by drilling with the bit 110 may include certain operating parameters, such as WOB, RPM, and drilling fluid flow rate. These operating parameters may be associated with a power draw from the drilling equipment. In this manner, the drilling system 100 may identify a predicted power demand and/or predicted power profile based on a planned operation from the drill plan.

In accordance with at least one embodiment of the present disclosure, the rig power management system may identify the predicted power demand based on the planned operation and generate a predicted operating profile for the rig power supply system 112. When the planned operation is set to begin, the rig power management system may implement the predicted operating profile. In some embodiments, the rig power management system may implement the predicted operating profile prior to identifying the change in the power demand on the drilling equipment. In some embodiments, the rig power management system may implement the predicted operating profile prior to starting the planned operation to prepare for the planned operation. In some embodiments, the rig power management system may implement the predicted operating profile at the same time as starting the planned operation. In this manner, the rig power management system may reduce inefficiencies in the operation of the rig power supply system 112 during transitions between operations.

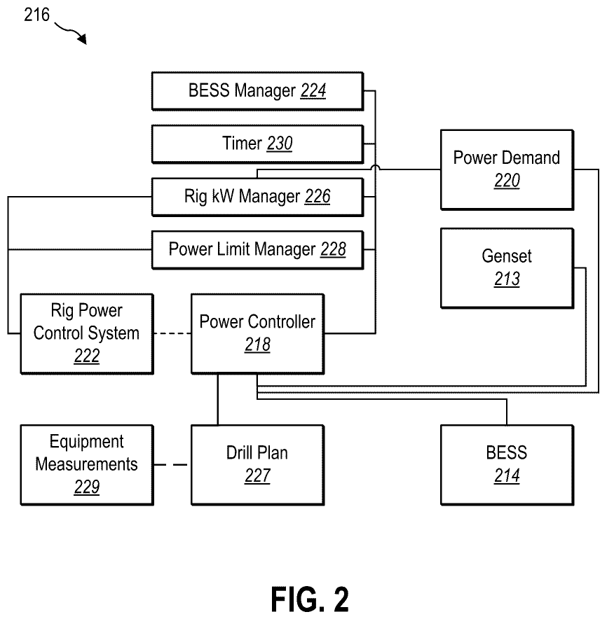

FIG. 2 is a schematic representation of a rig power management system 216, according to at least one embodiment of the present disclosure. The rig power management system 216 may include a power controller 218. As used herein, the power controller 218 may include any type of controller unit, such as a programmable logic controller (PLC), a personal computer (PC), an industrial PC, a digital control system (DCS), any other controller, and combinations thereof. The power controller 218 may manage the allocation of power of a genset 213 and a BESS 214 based on a rig power demand 220. The genset 213 may include a set of generators. The set of generators may include two or more generators that may be optionally turned on and off based on the power profile and/or the operating profile. The power controller 218 may control power at the genset 213 by instructing the genset 213 to start or stop one or more generators of the genset 213, including instructing the genset 213 to operate the generators at a given power output. For example, the power controller 218 may monitor the power demand 220 and, if the power demand 220 is greater than the power generation of the genset 213 and the BESS 214, then the power controller 218 may instruct the genset 213 to start or bring online one or more additional generators or connect an additional power source. In some examples, if the power demand 220 is less than the power generation of the genset 213, then the power controller 218 may instruct the genset 213 to turn off or take offline one or more generators. In this manner, operating the genset 213 may include operating the genset 213 at less than an entirety of the total number of generators.

The rig power management system 216 may include a rig power control system 222. The rig power control system 222 may control the operation of the genset 213. For example, the rig power control system 222 may regulate the rotational rate (e.g., in rotations per minute, RPM) of the generators of the genset 213, the frequency of the generators of the genset 213, the voltage of the generators of the genset 213, power output of the generators of the genset 213, control the load balance between the generators of the genset 213, and so forth. In some embodiments, the rig power control system 222 is independent from the power controller 218. For example, the power controller 218 may control which of the generators are activated, and the rig power control system 222 may control the operation of the activated generators. In some cases, the rig power control system 222 is implemented as part of the power controller 218. In some embodiments, the rig power control system 222 is a third-party controller. For example, the rig power control system 222 may be provided by the manufacturer of the genset 213. Maintaining the power controller 218 separate from the rig power control system 222 may facilitate a reduction in the processing load on the power controller 218. This may improve the responsiveness of the power controller 218 to changes in the power demand 220. In this manner, the power controller 218 may operate in real-time or near real-time to respond to sudden changes in the power demand 220.

The power controller 218 may include various managers, monitoring devices (e.g. communication modules, input/output modules, power monitoring devices, etc.), or other controllers (e.g. PLCs, remote PLC couplers, PC, industrial PCs, BESS 214 etc.) that monitor and provide input to determine which of the generators of the genset 213 to connect, turn on, and/or bring online. For example, the power controller 218 may include a BESS manager 224. The BESS manager 224 may be in communication with the BESS 214 and may monitor the SOC of the BESS 214. The BESS manager 224 may monitor any aspect of the SOC, including the SOC as a percentage of the energy storage capacity, the SOC as an amount of stored energy, the rate of change of the SOC (e.g., the rate of discharge, the rate of charging), the SOC of different portions of the BESS 214 (e.g., different cells, modules, or racks within the BESS 214), any other aspect of the SOC of the BESS 214, and combinations thereof. The power controller 218 may utilize the SOC to manage the operation of the genset 213. For example, if the power demand 220 is less than the efficiency threshold of the number of currently operating generators and the SOC of the BESS 214 is less than a SOC threshold, then the power controller 218 may connect the genset 213 to the BESS 214 to cause the genset 213 to charge the BESS 214. This may maintain the power demand 220 within the efficiency threshold of the genset 213 while increasing the SOC of the BESS 214. In some examples, the power demand 220 may increase above the efficiency threshold of the genset 213 and the BESS 214 may be above the SOC threshold. In this situation, the BESS 214 may supplement the power generation of the genset 213 with the BESS 214. This may allow the genset 213 to stay within the efficiency threshold for longer without adding an additional generator (which may cause all of the generators of the genset 213 to operate outside of the efficiency utilization).

The power controller 218 may further receive power consumption information from a rig kW manager 226. The rig kW manager 226 may receive information related to the power demand 220 from any location. For example, the rig kW manager 226 may receive power demand information by monitoring the outgoing power from the genset 213. In some examples, the rig kW manager 226 may receive power demand information from the rig power control system 222. In some examples, the rig kW manager 226 may receive power demand information from the genset 213. In some examples, the rig kW manager 226 may include multiple power monitors that may monitor the power draw from individual components that generate the power demand 220. In some examples, the rig kW manager 226 may be connected to a rig management system to identify which pieces of equipment are operating and their respective applied load. The power controller 218 may receive the power draw from the rig kW manager 226 to determine the power demand 220 on the drilling system. As discussed herein, the power controller 218 may use the power demand 220 to make decisions regarding the number of genset 213 operating and the operation of the BESS 214 with respect to the genset 213 (e.g., supplementing power to the genset 213, receiving charge from the genset 213).

The power controller 218 may further include a power limit manager 228. The power limit manager 228 may monitor the power limit of the genset 213. The power limit may be the maximum amount of power that the genset 213 can output before failure and/or damage to the genset 213. As discussed herein, the power demand 220 may fluctuate, at times in an unpredictable manner. The power limit manager 228 may work with or permit without interfering with the rig power control system 222 to maintain sufficient capacity in the power generation of the genset 213 to provide power during a power fluctuation. In some embodiments, the power limit manager 228 may help to determine the efficiency threshold of the genset 213. The power limit manager 228 may be in communication with the rig power control system 222 to manage operation of the genset 213.

In some cases, the power controller 218 may be in communication with a timer 230. The timer 230 may facilitate monitoring, measuring, and/or controlling one or more features over one or more monitoring periods. For example, in some cases, the power controller 218 takes (e.g., time-series) measurement data over a monitoring period to characterize the energy output of the genset 213, the power transfer to and/or from the BESS 214, etc. In some cases, the power controller 218 monitors the power status and/or identifies a power profile or a power supply pattern of one or more components of the rig power management system 216 over a monitoring period. In some cases, the power controller 218 monitors one or more aspects over a rolling or updating monitoring period, such as taking a rolling average over an advancing period of time of a set duration.

In some embodiments, the monitoring period may be in a range having an upper value, a lower value, or upper and lower values including any of 1 sec, 1 min., 2 min, 5 min., 10 min., 15 min., 20 min., 25 min., 30 min., 35 min., 40 min., 45 min., 50 min., 55 min., 1 hour, 1.5 hours, 2 hours, 3 hours, 4 hours, 6 hours, 9 hours, 12 hours, 18 hours, 1 day, 2 days, 3 days, 1 week, 1 month, 1 year or any value therebetween. For example, the monitoring period may be greater than 1 sec. In another example, the monitoring period may be less than 1 year. In yet other examples, the monitoring period may be any value in a range between 1 sec. and 1 year. In some embodiments, it may be critical that the monitoring period is between 15 min. and 45 min. to use the past performance of the rig power management system 216 to manage the power system of the rig power management system 216.

The power controller 218 may monitor any aspect of the power status of the rig power management system 216 over one or more monitoring periods to identify power profiles or power supply patterns. For example, the power controller 218 may monitor the power demand 220 over time. The power controller 218 may receive the power demand 220 over time from the rig kW manager 226. The power controller 218 may identify any type of power supply pattern, including the average power demand 220, increases in the power demand 220, decreases in the power demand 220, fluctuation patterns in the power demand 220 (e.g., power profiles, such as low power steady state, mid power steady state, high power steady state, high transient) any other trends in the power demand 220, and combinations thereof. The power controller 218 may receive the analysis of the power demand 220, including the power profile, and determine how to place the genset 213 within the efficiency utilization and/or determine how to extend the amount of time the genset 213 is maintained within the efficiency utilization by adjusting the timer 230. For example, the power controller 218 may determine that, based on the power supply pattern, the genset 213 may be maintained within the efficiency utilization for an additional period of time by supplementing power generation with the BESS 214. In some examples, the power controller 218 may determine that, based on the existing patterns identified by the power controller 218, the genset 213 may be maintained within the efficiency utilization for an additional period of time by charging the BESS 214. In some cases, the power controller 218 may identify, based on a monitoring period, an average power transfer rate at which power is exchanged with the BESS.

In accordance with at least one embodiment of the present disclosure, the power controller 218 may receive a drill plan 227. The drill plan 227 may include one or more planned operations, or operations that may be performed at a time after the power controller 218 has received measurements and/or identified a power profile. The drill plan 227 may include operating parameters for the drilling equipment based on the planned operations. For example, the drill plan 227 may include predicted operating parameters such as WOB, RPM, mud pump settings, and other predicted operating parameters that the drilling equipment may use to perform the predicted operation.

The power controller 218 may, based on or using the predicted operating parameters, generate a predicted power demand from the drilling equipment. For example, the power controller 218 may utilize historical information to identify the predicted power demand based on similar operating parameters identified in stored historic data. Based on the predicted power demand, the power controller 218 may generate a predicted operating profile for the genset 213 and the BESS 214. For example, based on the predicted power demand, the power controller 218 may generate a predicted operating profile that includes one or more generators operating at the utilization efficiency, combined with charging or discharging of the BESS 214, including charging or discharging the BESS 214 during transient operations.

The predicted operating profile may be different than the operating profile generated by the power profile determined from the power demand over the monitoring period. For example, the operating profile based on the monitoring period may anticipate the power demand and power profile using the power demand over the monitoring period. The predicted operating profile may anticipate the future power demand and power profile using the planned operation.

When the planned operation is about to begin and/or has begun, the power controller 218 may change the operation of the genset 213 and the BESS 214 in accordance with the predicted operating profile. As discussed herein, the power controller 218 may change the operation of the genset 213 and the BESS 214 using the predicted operating profile before the power controller 218 identifies a change in the power demand based on the change in the operation. This may facilitate improved power management. For example, changing to the predicted operating profile may reduce the introduction of large transients and other differentials between the power demand and the power generation during the transition between operations. The predicted operating profile may not exactly mirror the actual conditions in the field, changing to the predicted operating profile may facilitate a smoother transition in operating profiles, thereby reducing inefficiencies in the operation of the genset 213.

As a specific, non-limiting example, a planned operation may include tripping out of a wellbore, such as to change equipment at the BHA. The current operation may include drilling to advance the wellbore with a bit. The current operation may operate utilizing multiple generators supported by the BESS 214. The planned operation may utilize a single generator and no power from the BESS 214. The predicted operating profile may include a fully charged BESS 214 and operating the genset 213 at the efficiency utilization. The change to the predicted operating profile may include turning off generators as soon as the tripping out operation begins. In some embodiments, the change to the predicted operating profile may include charging the BESS 214 prior to turning off one or more of the generators.

As a specific, non-limiting example, a planned operation may include starting drilling after completing a survey with one or more downhole tools. In some embodiments, changing to the predicted operating profile may include turning on generators as drilling starts. This may reduce the reliance on the BESS 214 and improve the efficiency of the generators during startup.

In some embodiments, the drill plan 227 may be informed by equipment measurements 229. For example, the drill plan 227 may include a change in operation from a current operation to a planned operation based on certain metrics or parameters that are reached as indicated by measured equipment measurements 229. Such equipment measurements may include survey data, depth, formation type, dogleg severity, trajectory, azimuth, inclination, equipment measurements of surface equipment, and so forth. In some situations, actual conditions may differ from planned conditions. For example, a formation may not be at the planned depth, the drilling system may not achieve the desired dogleg severity, a formation may not have the planned properties, and so forth. The equipment measurements 229 may validate the ground-truth conditions. The drill plan 227 and/or the power controller 218 may receive the equipment measurements 229 and determine the planned operation based on the equipment measurements 229. For example, the drill plan 227 may be updated to an updated drill plan based on the equipment measurements 229, including received survey data. In some examples, the power controller 218 may implement the change to the planned operating profile based on the measured equipment measurements 229.

In some embodiments, the received equipment measurements 229 may facilitate the identification of unplanned operations, or short-term planned operations. Such short-term planning may be the result of equipment measurements 229, unplanned conditions, equipment breakdown, and so forth. The equipment measurements 229 may communicate with the drill plan 227 and/or the power controller 218 to identify that an unplanned operation is occurring, thereby providing greater advance notice to the power controller 218 than may be identified based on monitoring the power demand over the monitoring period.

In some embodiments, the unplanned operation may include a predicted end to unplanned downtime. For example, the operator may experience an unplanned downtime event for one or more reasons, such as damaged equipment, unexpected drilling conditions, and so forth. The operator may prepare a plan to resolve the reason leading to the unplanned downtime. In some embodiments, the operator may include a predicted end to the unplanned downtime, including when the drilling equipment may be turned on. In accordance with at least one embodiment of the present disclosure, the operator may add to the drill plan 227 the predicted end of the unplanned downtime and the power controller 218 may change the operating status to be based on the predicted end. In some embodiments, the drill plan 227 may be changed or adjusted to an adjusted drill plan including one or more adjusted planned operations based on unplanned or unscheduled events. In some embodiments, the drill plan 227 may include contingencies for unplanned or unscheduled events, and the drill plan 227 may be updated as soon as conditions indicate that the unplanned or unscheduled event has occurred.

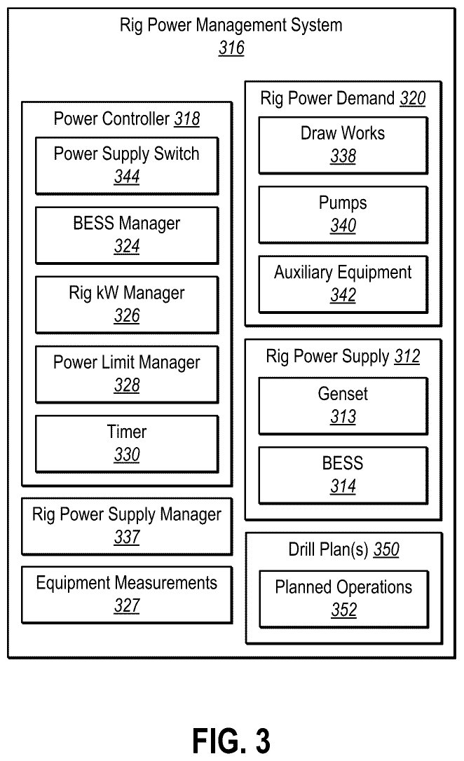

FIG. 3 is a representation of a rig power management system 316, according to at least one embodiment of the present disclosure. Each of the components of the rig power management system 316 can include software, hardware, or both. For example, the components can include one or more instructions stored on a computer-readable storage medium and executable by processors of one or more computing devices, such as a client device or server device. When executed by the one or more processors, the computer-executable instructions of the rig power management system 316 can cause the computing device(s) to perform the methods described herein. Alternatively, the components can include hardware, such as a special-purpose processing device to perform a certain function or group of functions. Alternatively, the components of the rig power management system 316 can include a combination of computer-executable instructions and hardware.

Furthermore, the components of the rig power management system 316 may, for example, be implemented as one or more operating systems, as one or more stand-alone applications, as one or more modules of an application, as one or more plug-ins, as one or more library functions or functions that may be called by other applications, and/or as a cloud-computing model. Thus, the components may be implemented as a stand-alone application, such as a desktop or mobile application. Furthermore, the components may be implemented as one or more web-based applications hosted on a remote server. The components may also be implemented in a suite of mobile device applications or “apps.”

The rig power management system 316 may manage the power distribution of a rig power supply 312. The rig power supply 312 may include any power source that provides power to a drilling rig. For example, the rig power supply 312 may include a genset 313 of one or more generators and a BESS 314 as described herein. In some cases, the rig power supply 312 may also include one or more other power sources, such as grid power, renewable power sources, or other types of energy storage systems which may store energy in other forms. A rig power supply manager 337 may manage the operation of the individual elements of the rig power supply 312. For example, the rig power supply manager 337 may manage the operation of the generators of the genset 313, including managing load, frequency, RPM, any other aspect of the generators, and combinations thereof. In some examples, the rig power supply manager 337 may manage the operation of any other element of the rig power supply 312, including managing local voltage transformation and distribution of grid power and/or renewable power sources.

The rig power management system 316 may monitor a rig power demand 320. The rig power demand 320 may originate from any source or equipment on the drilling rig. A non-exhaustive list of examples of drilling equipment may include a draw works 338, drilling fluid pumps 340, auxiliary equipment 342, any other drilling equipment, and combinations thereof.

In some embodiments, a rig power supply manager 337 manages the operations of individual rig equipment. For example, the rig power supply manager 337 may adjust the operation of one or more individual rig components to adjust the power demand. In some examples, the rig power supply manager 337 may reduce the speed of the draw works 338. In some examples, the rig power supply manager 337 may reduce the volume of mud pumped downhole by slowing down the pumps 340.

The rig power management system 316 may further include a power controller 318. The power controller 318 may manage which of the elements of the rig power supply 312 are connected to and provide power to supply the rig power demand 320. For example, the power controller 318 may include a power supply switch 344. The power supply switch 344 may be connected to the rig power supply 312 and may perform switches with a connection of the rig power supply 312 to connect or disconnect an element of the rig power supply 312 to supply the rig power demand 320.

In some embodiments, the power supply switch 344 connects different elements of the rig power supply 312 to the rig power demand 320. For example, the power supply switch 344 may connect the genset 313 and/or the BESS 314, or any other power source, and combinations thereof. As a specific, non-limiting example, the power supply switch 344 may facilitate connecting the genset 313 to provide a steady-state power, and may facilitate connecting the BESS 314 to provide supplemental power to accommodate changes to the steady-state power provided by the genset 313.

In some embodiments, the power supply switch 344 may connect different components of the same type of rig power supply 312. For example, the genset 313 may include multiple different generators. As the rig power demand 320 increases, the power supply switch 344 may connect additional generators to provide power for the rig power demand 320. As the rig power demand 320 decreases, the power supply switch 344 may disconnect one or more of the generators to increase the operating efficiency of the individual generators of the genset 313.

Each component of the rig power supply 312 may have an efficiency threshold. The efficiency threshold may be a utilization at which the particular component operates efficiently. For example, the genset 313 may have an efficiency threshold that may result in an efficient electrical power generation, as calculated by volume of fuel per unit at the electrical power generate value (e.g., kW per gallon/liter) as described herein. In some cases, the BESS 314 may have a particular SOC or SOC range at which the charge/discharge rate is increased and/or at which the charge/discharge sequence may reduce the degradation of the battery.

In accordance with at least one embodiment of the present disclosure, the power controller 318 may control which elements of the rig power supply 312 are connected to provide the rig power demand 320. To identify which elements of the rig power supply 312 to connect and/or disconnect, the power controller 318 may utilize one or more analysis managers. For example, the power controller 318 may include a rig kW manager 326. The rig kW manager 326 may monitor the power draw on the rig power demand 320 to determine how much power the rig power supply 312 is to supply. In some embodiments, the rig kW manager 326 may communicate with the rig power supply manager 337 to determine the power draw by the rig power demand 320. The power controller 318 may further include a power limit manager 328 that may analyze the power limit for the various elements of the rig power supply 312 and maintain a buffer to prevent the power limit from being exceeded by variations in the rig power demand 320. The power controller 318 includes a timer 330, which may facilitate analyzing or determining one or more trends, rates, and/or averages.

The power controller 318 includes a BESS manager 324, which may monitor and manage various aspects of the BESS 314. For example, the BESS manager 324 may monitor the SOC of the BESS 314. If the SOC of the BESS 314 is below an SOC threshold, the power supply switch 344 may cause the other elements of the rig power supply 312 to charge the BESS 314. If the BESS 314 is above the SOC threshold, the power controller 318 may permit the BESS 314 to provide power to satisfy the rig power demand 320 as needed.

In accordance with at least one embodiment of the present disclosure, the rig power management system 316 may include or receive one or more drill plans 350. The drill plans 350 may include planned operations 352. For example, as discussed herein, the drill plans may include multiple planned operations 352 to complete a wellbore or perform a project at a wellbore.

The power controller 318 may monitor the current status of the drilling operation. For example, the power controller 318 may receive equipment measurements 327. The equipment measurements 327 may provide an indication of the current operation being performed. In some embodiments, the power controller 318 may receive the current operation from an operator. The power controller 318 may identify the next planned operation 352. The next planned operation 352 may be the operation that may occur as part of the drill pan 350 after the current operation.

The power controller 318 may identify a predicted operating profile based in the next planned operation 352. For example, the power controller 318 may identify the predicted operating profile including the settings of the elements of the rig power supply 312 to perform the next planned operation. The power controller 318 may implement the predicted operating profile before the start of the next planned operation, or at the start of the next planned operation. In some embodiments, the power controller 318 may implement the predicted operating profile before the change in the power demand from the next planned operation 352 starts or happens. In this manner, the power controller 318 may facilitate increased efficiency of the operation of the rig power supply 312.

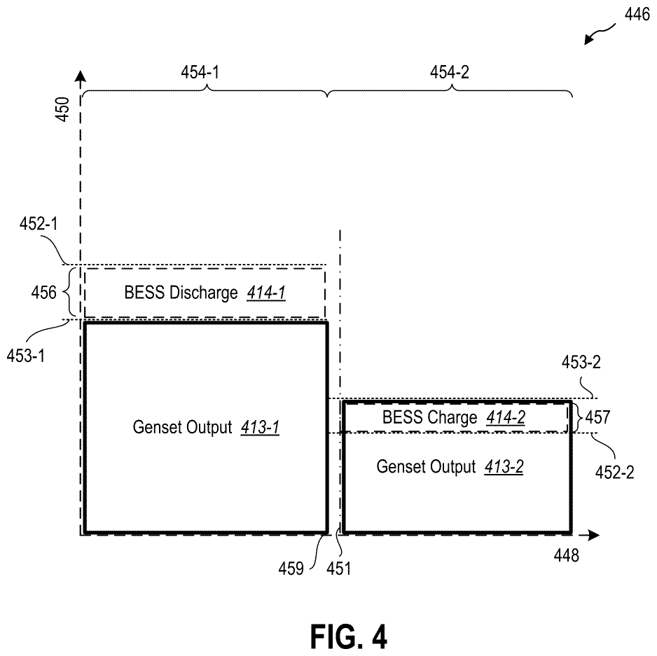

FIG. 4 is a representation of a power generation plot 446 having time 448 on the x-axis (e.g., horizontal axis) and power 450 on the y-axis (e.g., vertical axis). The power generation plot 446 indicates a first power demand 452-1 associated with a first operation of the drilling system. The first power demand 452-1 may represent the total power demand of the drilling system during the first operation. Over a first period 454-1, power to meet the first power demand 452-1 may be supplied by a first genset output 413-1 and a BESS discharge 414-1 with a discharge amount 456. While operating in the first period 454-1, the first genset output 413-1 may be operating at or near a first efficiency threshold 453-1 of the genset as described herein. In this way, the genset output 413-1 may correspond with the first efficiency threshold 453-1, or an increased (e.g., maximum) efficiency of the genset.

In accordance with at least one embodiment of the present disclosure, the drilling operation may include a second operation, to be completed over a second period 454-2. While performing the first operation in the first period 454-1, a planned operation may be planned to be performed during the second period 454-2. The planned operation may have a second power demand 452-2. The second power demand 452-2 may be met by a second genset output 413-2. In some embodiments, the second genset output 413-2 may include fewer numbers of generators than the genset output 413-1. In some embodiments, the second power demand 452-2 may be less than a second efficiency threshold 453-2, and the second genset output 413-2 may include charging 457 the BESS. While a specific combination of genset outputs 413 and BESS charge/discharge 414 is illustrated in FIG. 4, it should be understood that the techniques of the present disclosure may be applied to any arrangement or combination of genset output 413 and BESS charge/discharge 414, including no charge/discharge of the BESS.

The drilling operation may transition between the first operation and the second operation at a transition point 459. Conventionally, before transitioning from the first power output in the first period 454-1 to the second power output in the second period 454-2, the drilling system may operate with the first power output from the first period 454-1 after the transition point 459 until a power transition 451. At the power transition 451, the power controller may have identified the change in the power demand from the first power demand 452-1 to the second power demand 452-2, and the power controller may transition the gensets from the first genset output 413-1 to the second genset output 413-2. This may result in inefficient operation in the time between the transition point 459 and the power transition 451.

In accordance with at least one embodiment of the present disclosure, the power controller may transition the gensets from the first genset output 413-1 to the second genset output 413-2 at the transition point 459. Transitioning at the transition point 459 may reduce the duration at which the rig power system operates inefficiently based on the power demand. For example, transitioning at the transition point 459 may prevent the inefficient operation during the period of time between the transition point 459 and the power transition 451 during which, conventionally, the power controller is monitoring the change in power demand to determine if the change is a result of transients in the power demand or a change in the power profile.

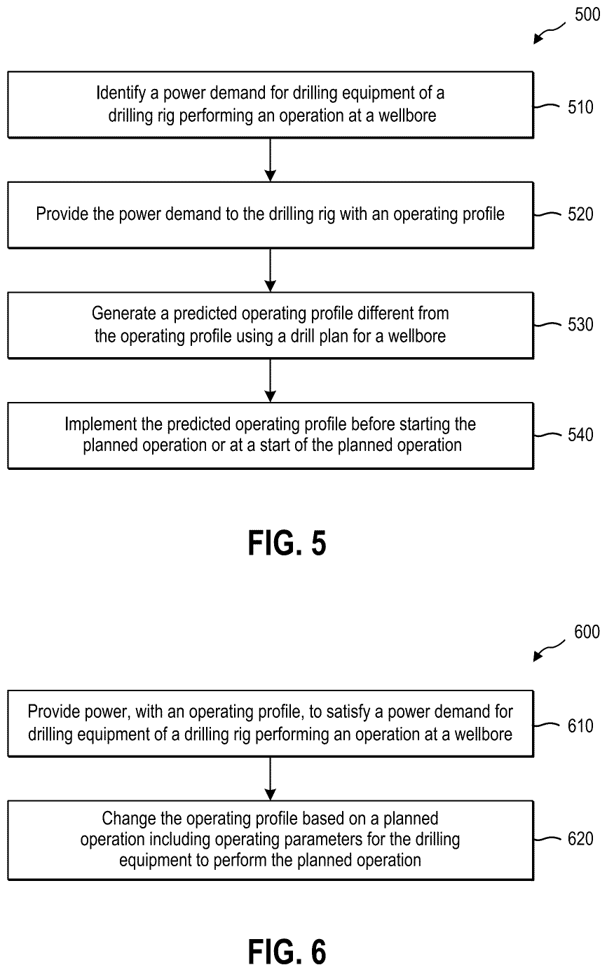

FIG. 5 and FIG. 6, the corresponding text, and the examples provide a number of different methods, systems, devices, and computer-readable media of the rig power management system. In addition to the foregoing, one or more embodiments can also be described in terms of flowcharts comprising acts for accomplishing a particular result, as shown in FIG. 5 and FIG. 6. FIG. 5 and FIG. 6 may be performed with more or fewer acts. Further, the acts may be performed in differing orders. Additionally, the acts described herein may be repeated or performed in parallel with one another or parallel with different instances of the same or similar acts.

As mentioned, FIG. 5 illustrates a flowchart of a series of acts or a method 500 for rig power management, according to at least one embodiment of the present disclosure. While FIG. 5 illustrates acts according to one embodiment, alternative embodiments may omit, add to, reorder, and/or modify any of the acts shown in FIG. 5. The acts of FIG. 5 can be performed as part of a method. Alternatively, a computer-readable medium can comprise instructions that, when executed by one or more processors, cause a computing device to perform the acts of FIG. 5. In some embodiments, a system can perform the acts of FIG. 5.

A rig power management system may identify a power demand for drilling equipment of a drilling rig performing an operation at a wellbore at 510. The rig power management system may provide the power demand to the drilling rig with an operating profile at 520. The operating profile may include a combination of at least one generator of a plurality of generators and stored energy capacity of an energy storage system. The rig power management system may generate a predicted operating profile different from the operating profile using a drill plan for a wellbore at 530. The drill plan includes a planned operation that includes operating parameters for the drilling equipment to perform the unplanned operation. The rig power management system may implement the predicted operating profile before starting the planned operation or at a start of the planned operation at 540.

In some embodiments, the rig power management system may, based on the planned operation, identify a predicted power profile for the drilling equipment. The rig power management system may generate the predicted operating profile based on the predicted power profile. In some embodiments, the rig power management system may generate the predicted operating profile based on changes to the operation. For example, the changes to the operation may include downtime for the operation. The downtime may include any downtime, including downtime to collect survey data, downtime as a result of equipment failure, downtime as a result of a health, safety, and environment (HSE) concern, any other downtime, and combinations thereof. In some embodiments, the change is a result of an unplanned operation. In some embodiments, the changes include a predicted end of the unplanned operation.

In some embodiments, the rig power management system may receive equipment measurements from one or more components of the drilling rig. The predicted operating profile may be based on the equipment measurements. As discussed herein, the equipment measurements may be any type of equipment measurements, such as a survey received from one or more downhole tools. In some embodiments, the drill plan may be updated to an updated drill plan using the survey.

As mentioned, FIG. 6 illustrates a flowchart of a series of acts or a method 600 for rig power management, according to at least one embodiment of the present disclosure. While FIG. 6 illustrates acts according to one embodiment, alternative embodiments may omit, add to, reorder, and/or modify any of the acts shown in FIG. 6. The acts of FIG. 6 can be performed as part of a method. Alternatively, a computer-readable medium can comprise instructions that, when executed by one or more processors, cause a computing device to perform the acts of FIG. 6. In some embodiments, a system can perform the acts of FIG. 6.

A rig power management system may provide power, with an operating profile, to satisfy a power demand for drilling equipment of a drilling rig performing an operation at a wellbore at 610. The operating profile includes a combination of generator power supplied by a set of generators and stored energy capacity of an energy storage system. The rig power management system may change the operating profile based on a planned operation including operating parameters for the drilling equipment to perform the planned operation at 620.

In some embodiments, changing the operating profile includes a turning on or turning off one of the set of generators using a power demand from the operating parameters. In some embodiments, the operating profile includes a balance between the set of generators and charging or discharging the energy storage system. In some embodiments, changing the operating profile includes changing the balance. In some embodiments, changing the operating profile includes changing the operating profile before starting the planned operation. In some embodiments, the power demand has a first power profile, and changing operating profile includes changing the operating profile based on a second power profile associated with the planned operation.

In some embodiments, the rig power management system receives equipment measurements from the drilling equipment and adjusts the planned operation based on the equipment measurements. The operating profile may be changed based on the adjusted planned operation and the equipment measurements.

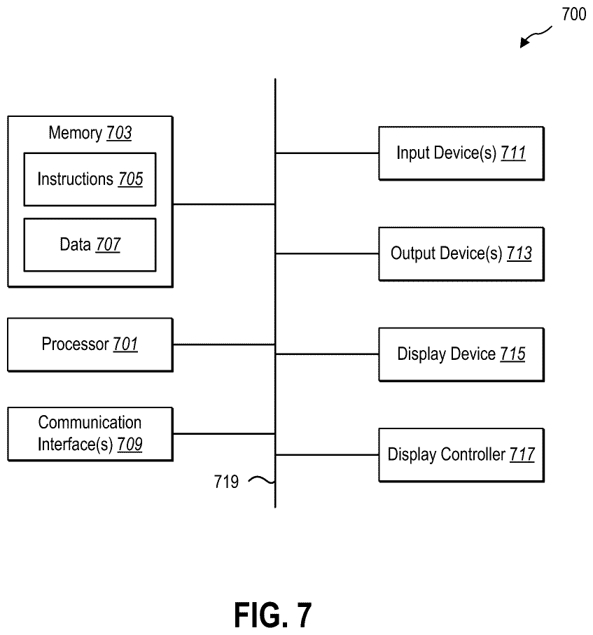

FIG. 7 illustrates certain components that may be included within a computer system 700. One or more computer systems 700 may be used to implement the various devices, components, and systems described herein.

The computer system 700 includes a processor 701. The processor 701 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 701 may be referred to as a central processing unit (CPU). Although just a single processor 701 is shown in the computer system 700 of FIG. 7, in an alternative configuration, a combination of processors (e.g., an ARM and DSP) could be used.

The computer system 700 also includes memory 703 in electronic communication with the processor 701. The memory 703 may be any electronic component capable of storing electronic information. For example, the memory 703 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 705 and data 707 may be stored in the memory 703. The instructions 705 may be executable by the processor 701 to implement some or all of the functionality disclosed herein. Executing the instructions 705 may involve the use of the data 707 that is stored in the memory 703. Any of the various examples of modules and components described herein may be implemented, partially or wholly, as instructions 705 stored in memory 703 and executed by the processor 701. Any of the various examples of data described herein may be among the data 707 that is stored in memory 703 and used during execution of the instructions 705 by the processor 701.

A computer system 700 may also include one or more communication interfaces 709 for communicating with other electronic devices. The communication interface(s) 709 may be based on wired communication technology, wireless communication technology, or both. Some examples of communication interfaces 709 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 700 may also include one or more input devices 711 and one or more output devices 713. Some examples of input devices 711 include a keyboard, mouse, microphone, remote control device, button, joystick, trackball, touchpad, and lightpen. Some examples of output devices 713 include a speaker and a printer. One specific type of output device that is typically included in a computer system 700 is a display device 715. Display devices 715 used with embodiments disclosed herein may utilize any suitable image projection technology, such as liquid crystal display (LCD), light-emitting diode (LED), gas plasma, electroluminescence, or the like. A display controller 717 may also be provided, for converting data 707 stored in the memory 703 into text, graphics, and/or moving images (as appropriate) shown on the display device 715.

The various components of the computer system 700 may be coupled together by one or more buses, which may include a power bus, a control signal bus, a status signal bus, a data bus, etc. For the sake of clarity, the various buses are illustrated in FIG. 7 as a bus system 719.

The embodiments of the rig power management system have been primarily described with reference to wellbore drilling operations; the rig power management system described herein may be used in applications other than the drilling of a wellbore. In other embodiments, rig power management system according to the present disclosure may be used outside a wellbore or other downhole environment used for the exploration or production of natural resources. For instance, rig power management system of the present disclosure may be used in a borehole used for placement of utility lines. Accordingly, the terms “wellbore,” “borehole” and the like should not be interpreted to limit tools, systems, assemblies, or methods of the present disclosure to any particular industry, field, or environment.

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers' specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for rig power management, comprising:
identifying a power demand for drilling equipment of a drilling rig performing an operation at a wellbore;
providing the power demand to the drilling rig with an operating profile, the operating profile including a combination of at least one generator of a plurality of generators and stored energy capacity of an energy storage system;
generating a predicted operating profile different from the operating profile using a drill plan for a wellbore, the drill plan including a planned operation, the planned operation including operating parameters for the drilling equipment to perform the planned operation; and
implementing the predicted operating profile before starting the planned operation or at a start of the planned operation.

2. The method of claim 1, further comprising, based on the planned operation, identifying a predicted power profile for the drilling equipment, and wherein, generating the predicted operating profile includes generating the predicted operating profile based on the predicted power profile.

3. The method of claim 1, wherein generating the predicted operating profile includes generating the predicted operating profile based on changes to the operation.

4. The method of claim 3, wherein the changes include downtime for the operation.

5. The method of claim 3, wherein the changes include an unplanned operation for the operation.

6. The method of claim 5, wherein the changes include a predicted end of the unplanned operation.

7. The method of claim 1, further comprising receiving equipment measurements from one or more components of the drilling rig, and wherein generating the predicted operating profile includes generating the predicted operating profile based on the equipment measurements.

8. The method of claim 7, wherein the equipment measurements include a survey received from one or more downhole tools.

9. The method of claim 8, wherein generating the predicted operating profile based on the equipment measurements includes generating the predicted operating profile based on an updated drill plan generated using the survey.

10. The method of claim 1, wherein implementing the predicted operating profile includes at least one of turning on one of the plurality of generators, turning off one of the plurality of generators, charging the energy storage system using the plurality of generators, or discharging the energy storage system to supplement the plurality of generators.

11. The method of claim 1, wherein implementing the predicted operating profile before the start of the planned operation or at the start of the planned operation includes implementing the predicted operating profile before identifying a change in the power demand for the drilling equipment.

12. A method for rig power management, the method comprising:
providing power, with an operating profile, to satisfy a power demand for drilling equipment of a drilling rig performing an operation at a wellbore, the operating profile including a combination of generator power supplied by a set of generators and stored energy capacity of an energy storage system; and
changing the operating profile based on a planned operation including operating parameters for the drilling equipment to perform the planned operation.

13. The method of claim 12, wherein changing the operating profile includes turning on or turning off one of the set of generators using a power demand from the operating parameters.

14. The method of claim 12, wherein the operating profile includes a balance between the set of generators and charging or discharging the energy storage system, and wherein changing the operating profile includes changing the balance between the set of generators and the charging or the discharging of the energy storage system.

15. The method of claim 12, wherein changing the operating profile includes changing the operating profile before starting the planned operation.

16. The method of claim 12, wherein the power demand has a first power profile, and wherein changing the operating profile includes changing the operating profile based on a second power profile associated with the planned operation.

17. The method of claim 12, further comprising:
receiving equipment measurements from the drilling equipment;
adjusting the planned operation based on the equipment measurements; and
changing the operating profile based on the adjusted planned operation and the equipment measurements.

18. The method of claim 17, wherein receiving the equipment measurements includes receiving survey data.

19. The method of claim 17, wherein receiving the equipment measurements includes receiving the equipment measurements of surface equipment.

20. A rig power supply system, comprising:
a drilling rig having one or more electronic components for performing drilling operations based on a power demand of the drilling rig;
a rig generator set (genset) of one or more generators;
a battery energy storage system (BESS);
a processor;
a memory in electronic communication with the processor; and
instructions stored in the memory which, when executed by the processor, cause the processor to:
identify the power demand for the drilling rig performing an operation at a wellbore;
provide the power demand to the drilling rig with an operating profile, the operating profile including a combination of the genset and the BESS;
generate a predicted operating profile different from the operating profile using a drill plan for a wellbore, the drill plan including a planned operation, the planned operation including operating parameters for the drilling equipment to perform the planned operation; and
implement the predicted operating profile before starting the planned operation or at a start of the planned operation.
